(19) United States
(12) Patent Application Publication
(10) Pub. No.: US 2024/0304170 A1
(43) Pub. Date: Sep. 12, 2024

(54) DYNAMICALLY MUTING CONVERSATIONS BASED ON CONTEXT

(71) Applicant: International Business Machines Corporation, Armonk, NY (US)

(72) Inventors: Aaron K. Baughman, Cary, NC (US); Shikhar Kwatra, San Jose, CA (US); Jeremy R. Fox, Georgetown, TX (US); Jagadesh Ramaswamy Hulugundi, Bangalore (IN); Raghuveer Prasad Nagar, Kota (IN); Sarbajit K. Rakshit, Kolkata (IN)

(21) Appl. No.: 18/180,267

(22) Filed: Mar. 8, 2023

(51) Int. Cl. G10K 11/178; G10L 21/034; G10L 25/78

(52) U.S. Cl. CPC G10K 11/17823; G10K 11/17827; G10K 11/17873; G10L 21/034; G10L 25/78; G10K 2210/108; G10K 2210/30231; G10K 2210/3027; G10K 2210/3044; G10L 2025/783

(57) ABSTRACT

A computer-implemented method dynamically mutes irrelevant sources of noise. The method includes identifying one or more sources of a noise in a vicinity of a listening device, where the listening device is associated with a user and the listening device includes a noise canceling function. The method also includes determining, for the user, a context, where the context represents a subject of a conversation related to the user. The method further includes calculating, for each of the one or more sources of noise, a relevance score. The method includes muting, by the listening device, each of the sources of noise where the associated relevance score is below a relevance threshold.

### BACKGROUND

The present disclosure relates to noise cancelation, and, more specifically, dynamically muting irrelevant noise and conversations based on current context.

Often individuals or groups of persons engaged in conversations can overhear unnecessary conversations in middle of their work or other tasks, and/or when involved during a different parallel conversation with some other person or any smart device. This occurs during many scenarios in day to day life, such as by-standers talking on the side, a teacher hearing whispers in a classroom, patients hearing a groaning sound of others in a hospital, fellow road travelers yelling to air their frustration while driving, conversations in crowded space, and the like.

### SUMMARY

Disclosed is a computer-implemented method to dynamically mute irrelevant sources of noise. The method includes identifying one or more sources of a noise in a vicinity of a listening device, where the listening device is associated with a user and the listening device includes a noise canceling function. The method also includes determining, for the user, a context, where the context represents a subject of a conversation related to the user. The method further includes calculating, for each of the one or more sources of noise, a relevance score. The method includes muting, by the listening device, each of the sources of noise where the associated relevance score is below a relevance threshold. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for dynamically muting irrelevant conversations, in accordance with some embodiments of the present disclosure.

FIG. 2 is a block diagram of a computing environment suitable for operation of a conversation manager, in accordance with some embodiments of the present disclosure.

FIG. 3 is a flow chart of an example mute irrelevant noise based on a current context, in accordance with some embodiments of the present disclosure.

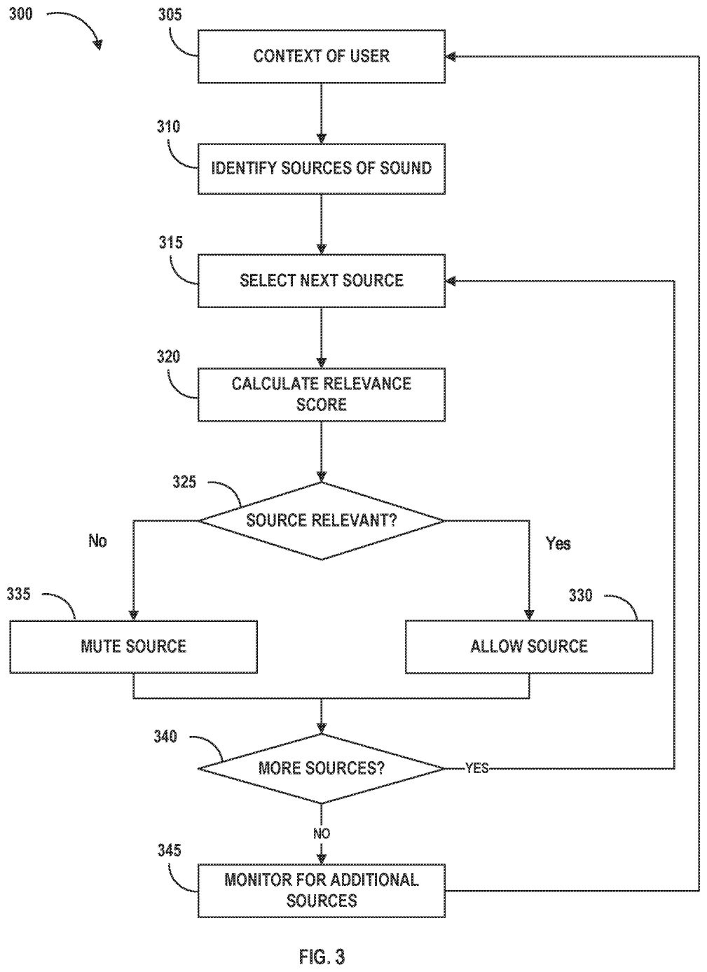

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamically muting irrelevant conversations and noise in block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

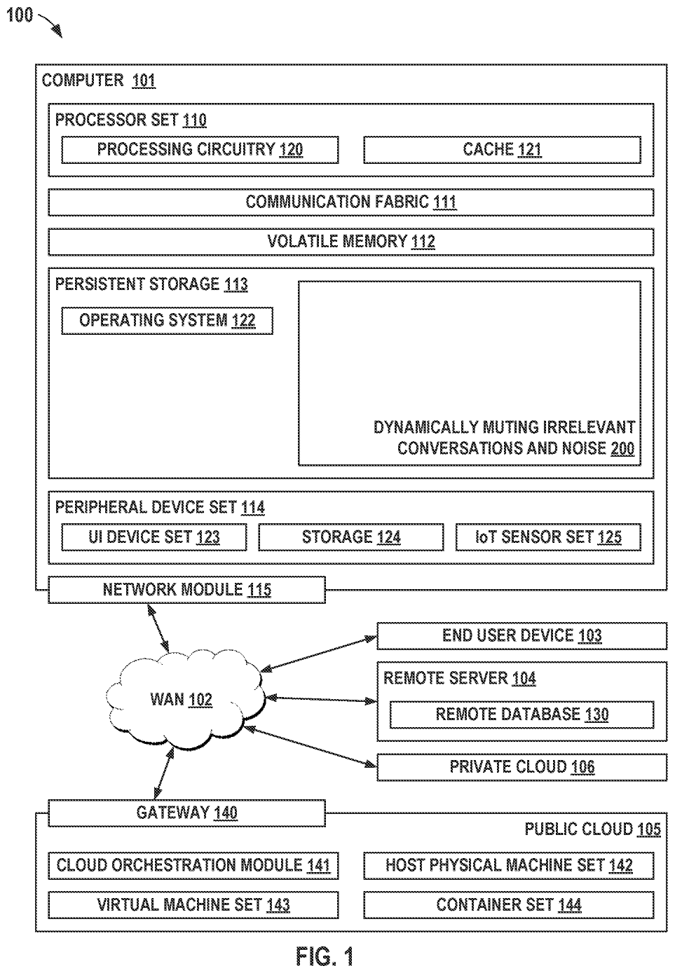

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to noise cancelation, and, more specifically, dynamically muting irrelevant noise and conversations based on current context.

Often individuals or groups of persons engaged in conversations can overhear unnecessary conversations in the middle of their work or other tasks. This occurs during many scenarios in day to day life, such as by-standers talking on the side, a teacher hearing whispers in a classroom, patients hearing a groaning sound of others in a hospital, fellow road travelers yelling to air their frustration while driving, conversations in crowded space, and the like.

In such scenarios, these situations are handled by humans with forced closing of one or both the ears, rolling up with windows from inside a car, stuffing in ear plugs, wearing noise cancelation headphones, raising voices to suppress unwanted conversation, etc. These actions are taken in a natural stimuli/response mode manually by the affected individual. When such natural intuition gets applied, an individual has less control to choose to hear the necessary or essential conversations versus unwanted conversations and noise. Such a situation creates a helplessness sense of an individual having no choice but to hear all conversation, regardless of his/her needs, versus completely not hearing anything at all. It may be a choice of hearing everything or nothing at all. In order to provide a better listening experience and/or reduce distracting noise, embodiments of the present disclosure can selectively and dynamically mute/limit various sounds in the presence of a user while not affecting (or amplifying) relevant conversations.

Embodiments of the present disclosure can reduce the amount of unwanted/irrelevant noise/conversations that can be heard by a user, and/or amplify the relevant and wanted conversations. Embodiments of the present disclosure include a conversation manager. The conversation manager can be configured to identity and filter/cancel/mute unwanted noise from a user while allowing relevant noise.

In some embodiments, the conversation manager can identify the current task/context of a user. The current task may include some audible component such as a conversation with one or more different persons. In some embodiments, the conversation manager can analyze the current state of the user. This can include location, tasks, calendar data, day of week, and any other factors that may determine whether a sound is relevant to the context of the user.

In some embodiments, the conversation manager identifies one or more sources of sound. The sources can be other persons speaking, music playing, background noise (e.g., humming of electronic/mechanical devices, etc.), and the like. The identification can include a location of the source, a type of sound and the like. In some embodiments, the sources are captured by microphones and/or other sensors in the vicinity of the user. Identifying the sounds can include determining a wave form for the sounds.

In some embodiments, the conversation manager calculates/determines a relevance score for each sound/source. The relevance score can indicate a predicted likelihood the user would want to hear the noise from that source. The factors can be location, sound type, volume, consistency, and the like. The conversation manager can then determine if the relevance score exceeds a relevance threshold for the identified sound. A relevance score above the threshold can consider sources to be relevant sources, and below the threshold, irrelevant sources. The threshold can be static and/or dynamic. In some embodiments, the conversation manager can mute the irrelevant sounds. The muting/canceling can include generating a waveform configured to cancel the natural wave form. Thus, the user only hears conversations and noises relevant to their current conversation or associated task. In some embodiments, the conversation manager can monitor the sources of sound, the context of the user, and/or the relevance of any sources. Based on the monitoring and the changing conditions, the conversation manager can update relevance scores, mute additional sources of sound, and/or unmute previously muted sounds.

Embodiments of the present disclosure can improve noise canceling techniques. Various embodiments can use a current context of the user, learned preferences, and inputs to identify, in real time, the relevance and irrelevance of sources and mute the irrelevant/unwanted noise. Even if the unwanted noise is another conversation in the vicinity of the user.

The aforementioned advantages are example advantages, and embodiments exist that can contain all, some, or none of the aforementioned advantages while remaining within the spirit and scope of the present disclosure.

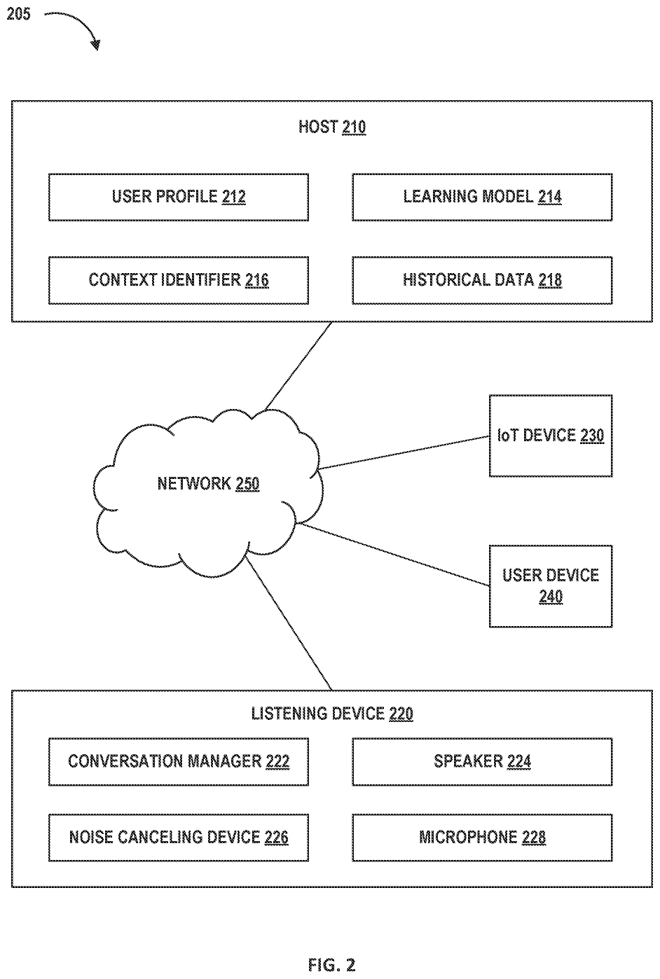

Referring now to various embodiments of the disclosure in more detail, FIG. 2 is a representation of a computing environment 205, that is capable of running the conversation manager in accordance with embodiments of the present disclosure. Many modifications to the depicted environment may be made by those skilled in the art without departing from the scope of the disclosure.

Computing environment 205 includes host 210, listening device 220, IoT device 230, mobile device 240, and network 250. Network 250 can be, for example, a telecommunications network, a local area network (LAN), a wide area network (WAN), such as the Internet, or a combination of the three, and can include wired, wireless, or fiber optic connections. Network 250 may include one or more wired and/or wireless networks that are capable of receiving and transmitting data, voice, and/or video signals, including multimedia signals that include voice, data, and video information. In general, network 250 may be any combination of connections and protocols that will support communications between and among host 210, listening device 220, IoT device 230, mobile device 240, and other computing devices (not shown) within computing environment 205. In some embodiments, component, including host 210, listening device 220, IoT device 230, mobile device 240, and other devices not shown, may include one or more of a computer system, such as computer 101 of FIG. 1. In some embodiments, host 210, listening device 220, IoT device 230, and mobile device 240, or any combination of their subcomponents, can be combined into a single device and/or any number of devices in various combinations. For example, listening device 220 can include host 210, the subcomponent of host 210, IoT device 230, and user device 240.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., public cloud 105 and/or private cloud 106 of FIG. 1). In some embodiments, host 210 includes user profile 212, learning model 214, context identifier 216, and historical data 218.

User profile 212 can include information about the user preferences. The preferences can be related to relevant and/or irrelevant sounds. In some embodiments, the preferences can be updated and/or be based on time, location, day, calendar information, and the like. For example, if a user is working in a crowded office space, they can indicate that all conversations are irrelevant, and/or all source locations that are associated with non-team members. In some embodiments, the preferences can be based on operating applications. For example, if the user has a web meeting application operating, only conversations related to the topic of the meeting may be considered relevant. However, if the user is using a music player or other similar entertainment application, then all conversations may be considered relevant.

Learning model 214 can be any combination of hardware and/or software configured to identify relevant conversations and/or a context of a user. In some embodiments, learning model 214 can include one or more separate models. In some embodiments, learning model 214 can determine if a sound source (or source) is relevant to a current task/conversation. The relevance can be based on inputs and recorded data from historical data 218, user profile 212, context identifier 216, conversation manager 222, IoT device 230, and/or user device 240.

In some embodiments, learning model 214 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, learning model 214 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Context identifier 216 can be any combination of hardware and/or software configured to identify a context of conversations. In some embodiments, context identifier includes, or is included in, learning model 214. In some embodiments, context identifier 216 can be configured to identify a context of the user's conversation and/or a context of additional conversations and noise sources. In some embodiments, context identifier 216 can include natural language processing (NLP). NLP can identify particular words and phrases. In some embodiments, the context can be based on words or phrases. In some embodiments, the context can be based on external inputs. The inputs can be manually input by a user and/or based on applications running, and/or other similar data. For example, if a user has a meeting about topic A on their calendar, conversation related to topic A may be considered as more likely to be relevant during the meeting.

Historical data 218 can be a set of data related to the user's previous conversations and/or relevancy inputs. In some embodiments, previous conversations and/or topics can be included in historical data 218. Historical data 218 can include inputs. Following a conversation, conversation manager 222 can request feedback on the relevancy determinations. The feedback can be used in future determinations. The feedback can be received through an input on user device 240.

Listening device 220 can be any combination of hardware and/or software configured to deliver sound to a human ear. In some embodiments, listening device 220 can be any device configured to generate sound for a human ear. The generated sound can be in response to hearing the sound and recreating the sound to pass to the ear. Listening device 220 can include headsets, headphone, smart speakers, mobile phones, computing devices, and the like. In some embodiments, listening device 220 can be wearable and/or removable. In some embodiments, listening device 220 can generate sound and/or allow the passage of outside sound. In some embodiments, listening device 220 includes conversation manager 222, speaker 224, noise canceling device 226, and microphone 228.

In some embodiments, listening device 220 can allow for natural sound to pass to the human hear with little or no impendence. In some embodiments, listening device 220 can capture and recreate the natural sounds. In some embodiments, listening device 220 can identify two or more sources of sound. The sources can produce sounds that originate from different sources. For example, a source can be each individual person talking, music players (e.g., instruments and/or digital music player), background noise, televisions, and the like. Each source can be distinguished from each other source based on the characteristics of the sound as it is being captured. The various sources can be determined to be relevant and/or irrelevant. Listening device 220 can selectively mute the irrelevant sources of sound. In some embodiments, the relevancy of sources can be determined by one or more leaning models.

Microphone 228 can be any combination of hardware and/or software configured to capture soundwaves. In some embodiments, microphone 228 can convert soundwaves into one or more electrical signals representing the sounds. In some embodiments, microphone 228 can hear and record/convert multiple sources concurrently. In some embodiments, the sources are separated during the conversion process, while in other embodiments, microphone 228 captures all sound data and sends to listening device 220 and/or its subcomponents. In some embodiments, listening device 220 includes two or microphone 228. The various microphones 228 can be located at different locations around listening device 220. In some embodiments, each source is captured from each microphone 228. The sound data can include additional non-sound (or meta) data. The non-sound data can include a time captured and which of microphones 228 the sound was converted from. The additional non-sound data can be used as factor in differentiating sources, identifying sources, and/or determining a location (or a direction) of the source. In some embodiments, the number of microphones 228 can be equivalent to a number of speakers 224 (e.g., one on each ear). In some embodiments, listening device 220 includes three or more microphones 228.

Speaker 224 can be any combination of hardware and/or software configured to generate sound. In some embodiments, speaker 224 is a loudspeaker. Speaker 224 can convert an electrical audio signal into a corresponding sound. In some embodiments, speaker 224 can generate a sound to mimic an input received by microphone 228. In some embodiments, speaker 224 can be integrated with noise canceling device 226 as described below.

In some embodiments, listening device 220 can include one or more speakers consistent speaker 224. The one or more speakers can be associated with each output from listening device 220. For example, if listening device 220 is a headset, there a be a speaker for each ear. In some embodiments, the two or more speakers can generate the same sounds at the same time. In some embodiments, speaker 224 can generate sound with a waveform opposite/shifted from sounds captured by listening device 220.

Noise canceling device 226 can be any combination of hardware and/or software configured to eliminate noise. In some embodiments, noise canceling device 226 can be incorporated into speaker 224. Noise canceling device 226 can send instructions to speaker 224 on what sound to generate. The instructions can be configured to create a canceling effect with the waveform of one or more identified noise sources.

In some embodiments, noise canceling device 226 can identify a wave form of a sound. The wave form can be altered. In some embodiments, the alteration can include shifting the wave by half a period and/or inverting the wave. The altered wave form is then sent to speaker 224 to generate sound. When the altered wave form and the original sound are both produced, they cancel each other out resulting in no sound.

Conversation manager 222 can be any combination of hardware and/or software configured to selectively mute/filter unwanted/irrelevant conversations. In some embodiments, conversation manager 222 can analyze each source of sound. In some embodiments, conversation manager 222 can determine which of the various sources are relevant and/or irrelevant. Listening device 220 can selectively mute the irrelevant sources of sound based on the analysis of conversation manager 222. In some embodiments, conversation manager 222 includes one or more of microphone 228, speaker 224, and noise canceling device 226. However, they are shown as separate for discussion purposes.

In some embodiments, the relevancy of sources can be determined by one or more leaning models (e.g., learning model 214). In some embodiments, conversation manager 222 can exchange information with host 210 and/or any or all of the subcomponents of host 210. In some embodiments, learning model 214, or an equivalent, can be incorporated into conversation manager 222. In some embodiments, conversation manager 222 can send the inputs to learning model 214 and then receive the outputs of the analysis. In some embodiments, analysis can determine which of the sources are irrelevant, and conversation manager 222 generates the waveform to cancel the irrelevant noise.

The analysis can determine one or more of a location of the source, a type of sound (e.g., conversation, background noise, etc.), and/or the like. In some embodiments, the relevance of a sound is based on a location of the source of the sound. The location can be determined by comparing all common sounds captured at the various microphones (e.g., microphone 228). In some embodiments, IoT device 230 and/or user device 240 can include one or more microphones consistent with microphone 228. The various locations of the captured sounds, and their times, can be used to determine a source of the location. In some embodiments, sounds that originate from locations relatively close to the user can be considered more relevant than sounds from sources from relatively more distant locations.

In some embodiments, the relevance depends on a context. The context can be a context of the user. In some embodiments, the user context is related to a conversation and/or task the user is currently engaged in. NLP can be used to identify a context of the current conversation. NLP can identify words and/or phrases and link the identified words to a topic/context. Each of the sound sources can be analyzed to determine if they are related to the current context. In some embodiments, if the topics of the other sources are similar to the current conversation, then the source may be considered relevant. If the topic of the source is unrelated to the current context, then the source may be considered irrelevant. For example, if NLP determines words related to listening to music are being said, and conversation manager 222 identifies music playing, the music may be relevant based on the context. However, if the conversation is about a project deadline, the same music can be considered irrelevant based on the context.

In some embodiments, the relevance is based on inputs from the user. The inputs can be audible and/or physical input. In some embodiments, conversation manager 222 can prompt the user to input relevance information. The user can indicate areas/locations of sources that are considered relevant/irrelevant.

In some embodiments, conversation manager 222 can generate a relevance score for each sound source. The relevance score can represent a likelihood (or predicted likelihood) that the sound from the source is relevant to the current user context. The relevance score can be based on the location of the sound, the volume, the frequency (e.g., continuous humming of a machine versus a loud one-time noise, like a breaking glass), type of sound (e.g., human sound versus background noise, etc.), and the like. In some embodiments, the context score can be based on data from user profile 212, user device 240, IoT device 230, and the like.

IoT Device 230 can be any device configured to capture and send data to conversation manager 222. In some embodiments, IoT device 230 can gather data configured to provide data input about relevancy of noise. In various embodiments, there can be any number of devices consistent with IoT device 230. Each device can include one or more sensors. A sensor can be any combination of hardware and/or software configured to gather data surrounding IoT device 230. IoT device 230 can have any number of sensors of any type. The type of sensors can include microphone, cameras, motion sensors, and the like. In various embodiments, IoT devices 230 can capture noise data used as an input to identify the source of data. The cameras can be used to identify locations and/or potential sources of noise/conversations.

User device 240 can be any type of portable computing device. In some embodiments, computing environment 205 includes any number of devices consistent with user device 240. In some embodiments, user device 240 can capture data and provide relevancy analysis inputs consistent with IoT device 230. Additionally, user device 240 can include global positioning systems (GPSs), and short-range networking capabilities (e.g., Bluetooth). The GPS can be used to determine locations for the user device and any other devices connected to other persons. The short-range networking can be an input into relevancy. For example, if the user's device and a second device can detect the presence of each other through the short-range network, then this can be an input that the conversations between the two devices is likely relevant.

Process 300 can be implemented by one or more processors, host 210, user profile 212, learning model 214, context identifier 216, historical data 218, listening device 220, conversation manager 222, speaker 224, noise canceling device 226, microphone 228, IoT device 230, user device 240, and/or a different combination of hardware and/or software. In various embodiments, the various operations of process 300 are performed by one or more of host 210, user profile 212, learning model 214, context identifier 216, historical data 218, listening device 220, conversation manager 222, speaker 224, noise canceling device 226, microphone 228, IoT device 230, user device 240. For illustrative purposes, the process 300 will be described as being performed by conversation manager 222.

At operation 305, conversation manager 222 determines a context for a user. In some embodiments, determining the context includes identifying that the user is participating in a conversation. The context can further include a topic of the conversation. The determination can involve analyzing what the speaker is saying, historical data 218, and other inputs. In some embodiments, learning model 214, context identifier 216, and/or conversation manager 222 can determine the context. The context can include a conversation is occurring, the topic of the conversation, and the like. In some embodiments, the context can include a task currently being performed and/or scheduled for completion.

At operation 310, conversation manager 222 identifies one or more sources of sound. In some embodiments, the identification includes receiving sound waves. The identification can include converting the sounds into electrical signals by microphone 228. The electrical signal can represent a frequency, amplitude, and/or period of the captured wave. In some embodiments, the capturing includes non-sound (meta) data. The sound data and the non-sound data can be combined into a set of sound data (or source data). The sound can be received by one or more of listening devices 220, IoT device 230, and/or user device 240. The device that receives the sound can be included in the source data. Operation 310 includes differentiating the sound waves into one or more separate sources. The amplitude, frequency, and/or location of the captured waves can be used to identify the sources, using one or more of listening devices 220, IoT device 230, and/or user device 240. The various sets of sound data can be sent to conversation manager 222, which then compares the various sources to determine which sets are duplicate (or represent the same source).

In some embodiments, operation 310 includes identifying a location of one or more of the identified sources. The non-sound data in the set of sound data can include a capture time. In some embodiments, the non-sound data can be used to determine a location of each source. In some embodiments, inputs from IoT device 230 and user device 240 can be inputs to the location determination. In some embodiments, conversation manager 222 can compare the time each of the matching sources were received. From the various points, an estimated location of the source can be determined. In some embodiments, GPS, IoT sensor data, and other inputs can be used to determine the location.

At operation 315, conversation manager 222 selects a next source. In some embodiments, the next source is a first source. In some embodiments, the next source is any subsequent source after the first source. The sources can be analyzed in any order and/or concurrently. In some embodiments, the selected source is based on the location of the source. For example, the sources can be selected based on relative distance to the user. In some embodiments, the selected source is based on a sound type. Various sound types can be ranked, and the higher ranked sources can be analyzed first. For example, human voice can be the top rank. Conversation manager 222 will then analyze each human voice sound origin prior to moving to non-voice sounds sources.

At operation 320, conversation manager 222 calculates a relevance score for the selected source. The relevance score can represent a likelihood a sound is relevant to a conversation/task of a user. Generally, the higher the score, the more relevant the sound. However, in some embodiments, lower scores can be relatively more relevant. In some embodiments, the relevance score can be calculated by one or more of conversation manager 222, learning model 214, and context identifier 216; however, all actions will be described below as being performed by conversation manager 222. In some embodiments, the relevance score is based on the context of the conversation of the user and/or a task being performed by the user. conversation manager 222 can analyze the sound and compare its contents against the current topic/task of the user.

At operation 325, conversation manager 222 determines if the source is relevant. In some embodiments, the source is relevant if the associated relevance score is below/above a relevance threshold. In some embodiments, user profile 212, historical data 218 and/or other similar factors may be used. In some embodiments, the threshold is a predetermined threshold. It follows that any source of sound that has a score above/below the threshold can be considered relevant. In some embodiments, the threshold is dynamic. The dynamic threshold can be based on the number of sources, relative scores, and the like. In some embodiments, the top number of relevance scores can be considered relevant. For example, the two sources with the highest relevance scores can be considered relevant. In some embodiments, the threshold can be based on a percentage of the sources. For example, the top 10% of relevance score can be considered relevant sources.

If it is determined that the sound source is relevant (325: YES), then conversation manager 222 proceeds to operation 330. If it is determined the sound source is not relevant (325: NO), then conversation manager 222 proceeds to operation 335.

At operation 330, conversation manager 222 allows the sound to proceed to the user. In some embodiments, the allowing includes not muting or taking any action to diminish the natural sound. In some embodiments, the allowing includes generating the sound as identified. The generation can be performed by speaker 224. Upon completion of operation 330, conversation manager 222 proceeds to operation 340.

At operation 335, conversation manager 222 mutes the source. In some embodiments, the muting includes initiating the sound canceling function of noise canceling device 226. Conversation manager 222 generates (or instructs noise canceling device 226) to generate sound waves configured to cancel out the wave form of the associated source.

At operation 340, conversation manager 222 determines if there are additional sources to be scored. In some embodiments, there are additional sources if there are any sources remaining that do not have an associated relevance score. In some embodiments, there are additional sources if conversation manager 222 determines a new source is identified. In some embodiments, there are additional sources if a context changes. In some of these embodiments, conversation manager 222 can return to operation 305 to determine a new context. If it is determined that the there are additional sources to score (340: YES), then conversation manager 222 returns to operation 320. If it is determined the there are no additional sources to score (340: NO), then conversation manager 222 proceeds to operation 345.

At operation 345, conversation manager 222 monitors for changes in the conversation of the user. In some embodiments, the change can include identifying a new source and/or determining a source is no longer there. In some embodiments, the change can include updating/determining a change in context/task of the user. A change in context can render the relevance scores moot, and/or in need of update. As such, conversation manager 222 can return to any of the previous operations to maintain muting of irrelevant conversations in real time. Process 300 depicts conversation manager 222 returning to operation 305.

In some embodiments, process 300 can be altered. For example, rather than a loop, conversation manager 222 can process each step for each identified source prior to moving to the next operation. For example, if conversation manager 222 determines there are four sources at operation 310, it can calculate all four source scores at operation 315 before proceeding to operation 320, and so on.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying one or more sources of a noise in a vicinity of a listening device, wherein the listening device is associated with a user and the listening device includes a noise canceling function;
determining, for the user, a context, wherein the context represents a subject of a conversation related to the user;
calculating, for each of the one or more sources of noise, a relevance score; and
muting, by the listening device, each of the sources of noise where the associated relevance score is below a relevance threshold.

2. The computer-implemented method of claim 1, wherein the identifying further comprises:
capturing, by a microphone on the listening device, each of the one or more sources of noise; and
converting, in response to the capturing, each noise into a waveform.

3. The computer-implemented method of claim 2, wherein the muting further comprises:
generating, by the listening device, a cancelation wave, wherein the cancelation wave is configured to cancel the waveform of the noise.

4. The computer-implemented method of claim 2, wherein the identifying further comprises:
determining a location for each source of noise.

5. The computer-implemented method of claim 1, further comprising:
determining a second relevance score for a second sound is above the relevance threshold; and
allowing, in response to the determining the second relevance score is above the relevance threshold, the second sound to pass through the listening device.

6. The computer-implemented method of claim 5, wherein a second source of the second sound is a second person in a conversation with the user.

7. The computer-implemented method of claim 6, wherein a first source of sound is a second user.

8. The computer-implemented method of claim 7, wherein the second source of sound is from a third user.

9. The computer-implemented method of claim 1, wherein the context is at least partially based on an open application on a user device.

10. The computer-implemented method of claim 1, wherein the threshold is based on a highest relevance score of the one or more relevance scores.

11. A system comprising:
a processor; and
a computer-readable storage medium communicatively coupled to the processor and storing program instructions which, when executed by the processor, are configured to cause the processor to:
identify one or more sources of a noise in a vicinity of a listening device, wherein the listening device is associated with a user and the listening device includes a noise canceling function;
determine, for the user, a context, wherein the context represents a subject of a conversation related to the user;
calculate, for each of the one or more sources of noise, a relevance score; and
mute, by the listening device, each of the sources of noise where the associated relevance score is below a relevance threshold.

12. The system of claim 11, wherein the stored program instructions for identification of the one or more sources are further configured to cause the processor to:
capture, by a microphone on the listening device, each of the one or more sources of noise; and
convert, in response to the capturing, each noise into a waveform.

13. The system of claim 12, wherein the stored program instructions for muting are further configured to cause the processor to:
determine a location for each source of noise.

14. The system of claim 11, wherein the stored program instructions are further configured to cause the processor to:
determine a second relevance score for a second sound is above the relevance threshold; and
allow, in response to the determination the second relevance score is above the relevance threshold, the second sound to pass through the listening device.

15. The system of claim 14, wherein a second source of the second sound is a second person in a conversation with the user.

16. A computer program product, the computer program product comprising a computer readable storage medium having program instructions embodied therewith, the program instructions executable by a processing unit to cause the processing unit to:
identify one or more sources of a noise in a vicinity of a listening device, wherein the listening device is associated with a user and the listening device includes a noise canceling function;
determine, for the user, a context, wherein the context represents a subject of a conversation related to the user;
calculate, for each of the one or more sources of noise, a relevance score; and
mute, by the listening device, each of the sources of noise where the associated relevance score is below a relevance threshold.

17. The computer program product of claim 16, wherein the stored program instructions for identification of the one or more sources are further configured to cause the processing unit to:
capture, by a microphone on the listening device, each of the one or more sources of noise; and
convert, in response to the capturing, each noise into a waveform.

18. The computer program product of claim 17, wherein the stored program instructions for muting are further configured to cause the processing unit to:
determine a location for each source of noise.

19. The computer program product of claim 16, wherein the stored program instructions are further configured to cause the processing unit to:
determine a second relevance score for a second sound is above the relevance threshold; and
allow, in response to the determination the second relevance score is above the relevance threshold, the second sound to pass through the listening device.

20. The computer program product of claim 19, wherein a second source of the second sound is a second person in a conversation with the user.
